(19) United States
(12) Patent Application Publication
(10) Pub. No.: US 2014/0074566 A1
(43) Pub. Date: Mar. 13, 2014

(54) Remote Sensing of Vehicle Occupancy

(71) Applicants: James K. McCoy, Garland, TX (US); Jeffrey A. Garrett, Allen, TX (US)

(72) Inventors: James K. McCoy, Garland, TX (US); Jeffrey A. Garrett, Allen, TX (US)

(21) Appl. No.: 14/024,338

(22) Filed: Sep. 11, 2013

Related U.S. Application Data
(60) Provisional application No. 61/699,390, filed on Sep. 11, 2012.

(51) Int. Cl. G07B 15/06

(52) U.S. Cl. CPC G07B 15/063
USPC 705/13

(57) ABSTRACT

One or more sensors are interfaced to a controller which in turn interfaces to a transponder in order to provide occupancy status of a vehicle. The one or more sensors determine the occupancy status of one or more of the seats in the vehicle, and report this to the controller. The controller determines an overall occupancy for the vehicle, and provides this information to the transponder. The transponder then communicates this information to a traffic monitoring or toll collection infrastructure, such as to a toll tag reading tower using Radio Frequency Identification (RFID) wireless communication. The collected information may then be used to reduce or eliminate manual occupancy verification by police, and to enable incentive-based toll policy.

### CROSS-REFERENCE TO RELATED APPLICATION(S) CLAIMING BENEFIT TO AN EARLIER-FILED PATENT APPLICATION

Benefit is claimed to the filing date of U.S. Provisional Patent Application Ser. No. 61/699,390, our docket PPA2012KMC1, filed on Sep. 11, 2012.

### Incorporation by Reference

The related U.S. Provisional Patent Application Ser. No. 61/699,390, our docket PPA2012KMC1, filed on Sep. 11, 2012 is hereby incorporated by reference in its entirety.

### FEDERALLY SPONSORED RESEARCH AND DEVELOPMENT STATEMENT

None.

### MICROFICHE APPENDIX

Not applicable.

### FIELD OF THE INVENTION

The invention generally relates to technologies for determining occupancy of a vehicle for compliance with traffic regulations such as high occupancy vehicle (HOV) lanes and occupancy-based toll roads.

### BACKGROUND OF INVENTION

Many urban jurisdictions have built or implemented a variety of methods to reduce vehicle traffic, congestion, and to encourage higher occupancy of vehicles, such as installation of and control of high occupancy vehicle (HOV) lanes, toll roads, and car pool tax credits.

While cameras have been recently implemented to assess tolls to vehicles on toll roads by automatically recognizing a license plate in a photograph captures of a vehicle as it passes a poll station, enforcement of occupancy requirements of some lanes has remained primarily a manual process through policing because cameras outside of a vehicle cannot obtain a view of occupants or empty seats behind heavily tinted windows, panels, and the like.

### SUMMARY OF EMPLARY EMBODIMENTS OF THE INVENTION

One or more sensors are interfaced to a controller which in turn interfaces to a transponder in order to provide occupancy status of a vehicle. The one or more sensors determine the occupancy status of one or more of the seats in the vehicle, and report this to the controller. The controller determines an overall occupancy for the vehicle, and provides this information to the transponder. The transponder then communicates this information to a traffic monitoring or toll collection infrastructure, such as to a toll tag reading tower using Radio Frequency Identification (RFID) wireless communication. The collected information may then be used to reduce or eliminate manual occupancy verification by police, and to enable incentive-based toll policy.

### BRIEF DESCRIPTION OF THE DRAWINGS

The figures which considered in view of the disclosure form a complete disclosure of how to make and use at least one embodiment of the present invention.

FIG. 1 illustrates a vehicle equipped with at least on sensor unit, a control unit and a transponder unit, which communicates to a toll tower and to a toll accounting system.

FIG. 2 sets forth a generalized computing platform suitable for implementing at least the control unit portion of an embodiment of the present invention.

### DETAILED DESCRIPTION OF EXEMPLARY EMBODIMENT(S) OF THE INVENTION

The inventors of the present and the related invention have recognized problems not yet recognized by those skilled in the relevant arts of traffic engineering, vehicle monitoring, and road regulation policy making.

Determining vehicle occupancy for toll-roads is useful in setting occupancy-based tolls in order to control motorway congestion and more efficiently use the motorways. When a toll authority is enabled to accurately determine the occupancy status of each vehicle, toll incentives may be offered to vehicle operators who transport larger numbers of occupants in their vehicles, while penalties may be accurately assessed to those who utilize infrastructure such as HOV lanes without meeting the occupancy requirements.

Embodiments of this invention include devices or systems that can be installed within an automobile or other vehicle to determine the number of vehicle occupants within a specified transmission range, and to communicate occupancy status to a toll-collection infrastructure. At least one embodiment employs the radio-frequency identification (RFID) infrastructure commonly used in automated toll collection today, but other embodiments may use other forms of wireless communication such as, but not limited to, BlueTooth, Wi-Fi, infrared, etc.

A variety of “presence detection” methods may be used alone or in concert to determine occupancy inside the vehicle, including passive infrared motion sensor(s), ultrasonic motion sensor(s), thermopile sensor(s), infrared-sensitive digital camera(s), visible-light or other passive sensor(s) to measure body motion and/or body temperature at a distance. Further, human body or facial characteristics may also be used for this determination.

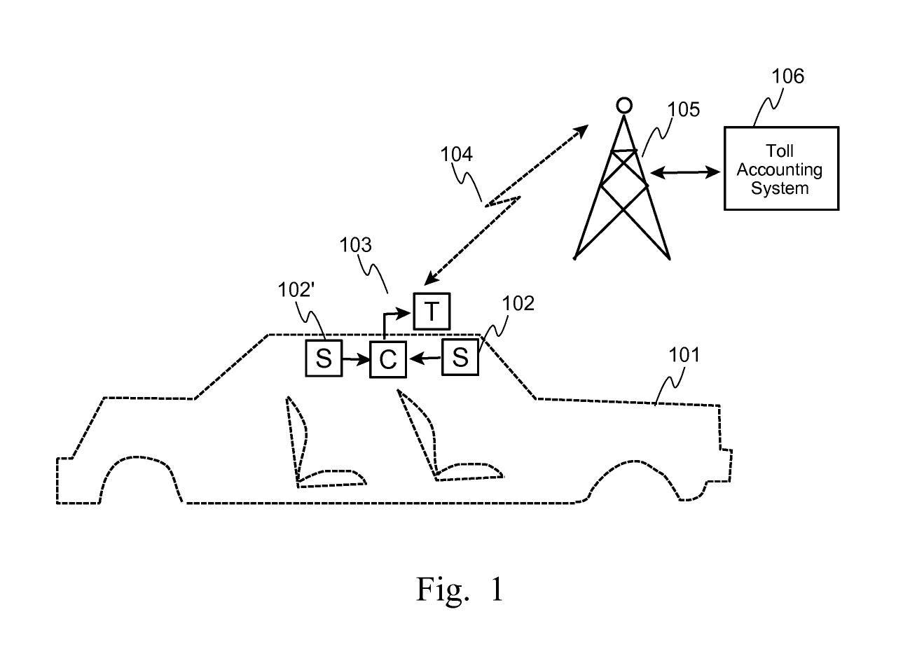

Referring now to FIG. 1, embodiments of this invention may use one or more sensors (102, 102′) to determine if someone is occupying one of several positions in a vehicle (101), e.g. front passenger seat, rear driver side, rear middle or rear passenger side seat. For cost purposes, it is not necessary to implement an occupancy detector for the driver, as it can be reasonably presumed that each moving vehicle which is travelling on a roadway is at least occupied by a driver.

One available embodiment would be to place a “sensor unit” (102, 102′) containing one or more of the presence detection technologies on the inside of the vehicle (101) such that the sensor unit has an unobstructed view of the one or more passenger seats. One or more of the presence detection methods would be used to determine if someone is occupying the one or more passenger seats. This information would be communicated to an associated “control unit” (110) containing electronic circuits or processor employing software to determine the presence of a live human, distinguishing it from an object or an animal.

This “control unit” (110) would then communicate the occupancy information to a “transponder unit” (103) that would communicate (104) this information to the toll tag antenna or tower (105) system deployed at sites along the motorway using a wireless communications technology such as RFID. Such embodiments of this invention would be able to make use of existing RFID technology and systems already deployed for toll collection and other purposes by using the same RFID frequencies, modulation methods and data protocols.

Additional sensor units (102′) may be aimed at or placed near the rear seat to make the same determination for that location. If precise seat occupancy is needed, then it may be necessary to deploy or aim a sensor towards that location. Otherwise, the sensor field of view could encompass a wider area of the rear seat and provide an indication of occupancy, but maybe not an exact count.

A transponder unit, control unit and one or more sensor units could be packaged together or separately. If packaged separately, then either wired or wireless communication methods would be used to transfer information between the sensor unit(s), control unit and transponder unit.

It is desired that installation and operation be simple and reliable, therefore at least one embodiment would be sensor units, a control unit and transponder unit packaged together and operating on battery powered or solar powered, and placed on the front dashboard of the vehicle such that the transponder unit has an RF path outside the vehicle and the sensor unit(s) have a view towards the passenger and rear seats.

Suitable Computing Platform. The preceding paragraphs have set forth example logical processes according to the present invention, which, when coupled with processing hardware, embody systems according to the present invention, and which, when coupled with tangible, computer readable memory devices, embody computer program products according to the related invention.

Regarding computers for executing the logical processes set forth herein, it will be readily recognized by those skilled in the art that a variety of computers are suitable and will become suitable as memory, processing, and communications capacities of computers and portable devices increases. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

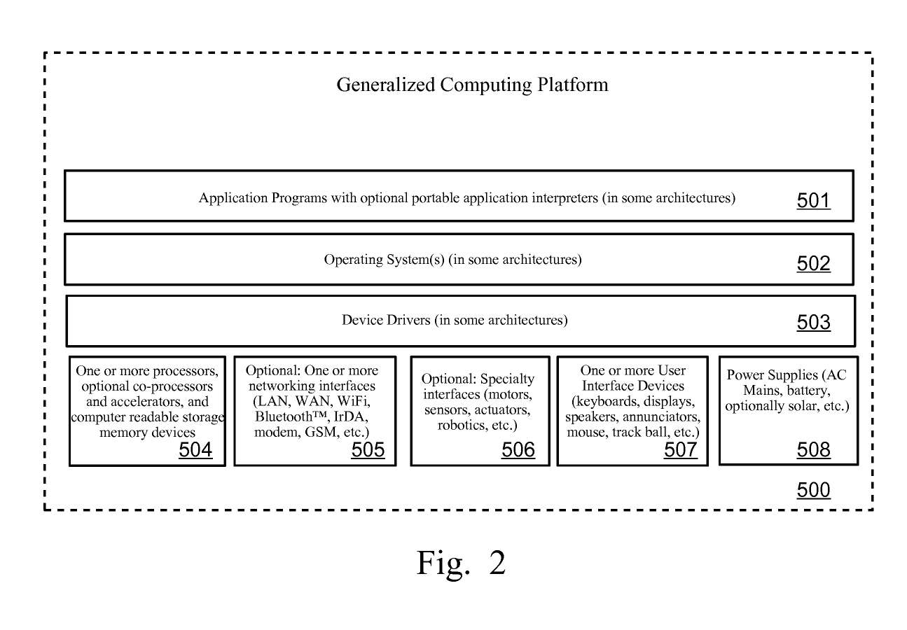

The present invention may be realized for many different processors used in many different computing platforms. FIG. 2 illustrates a generalized computing platform (500), such as common and well-known computing platforms such as “Personal Computers”, and portable devices such as personal digital assistants and smart phones, running a popular operating systems (502) such as Microsoft™ Windows™, Google Android™, Microsoft Windows Mobile™, UNIX, LINUX, Apple iPhone iOS™, and others, may be employed to execute one or more application programs to accomplish the computerized methods described herein. Other suitable computing platforms include embedded processing and control modules, such as those based on the well-known Microchip Technology™ PIC microcontroller provided with suitable software or firmware functions, or even certain mobile computers such as smart phones.

Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (501) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (504) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (505) may be provided, as well as specialty interfaces for specific applications. If the computing platform is intended to interact with human users, it is provided with one or more user interface devices (507), such as display(s), keyboards, pointing devices, speakers, etc. And, each computing platform requires one or more power supplies (battery, AC mains, solar, etc.).

Conclusion. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process(es).

It will be readily recognized by those skilled in the art that the foregoing example embodiments do not define the extent or scope of the present invention, but instead are provided as illustrations of how to make and use at least one embodiment of the invention.

I/we claim:

1. A system for use in an automobile or other roadway vehicle to determine the number of vehicle occupants within a specified transmission communication range, and to communicate occupancy status to a toll-collection infrastructure, the system comprising:
one or more passive, non-contact seat occupancy detectors provided to a passenger-carrying vehicle excluding a weight detector and a seat restraint closure detector;
a transmitter for communicating to a roadway toll collection infrastructure system; and
a controller for receiving inputs from the one or more seat occupancy detectors, for determining based on the inputs which of a plurality of seats in the vehicle are likely occupied by a human occupants, for counting the human occupants and for transmitting the count via the transmitter to the toll collection infrastructure system.

2. The system as set forth in claim 1 wherein the seat occupancy detector comprises at least one detector selected from the group consisting of a passive infrared motion sensor, an ultrasonic motion sensor, a thermopile sensor, an infrared-sensitive digital camera, a visible-light sensor, a body motion sensor, a non-contact body temperature sensor, a camera-based human body recognizer, and a camera-based facial recognizer;

3. The system as set forth in claim 1 wherein the counting comprises counting human occupants in at least one seat selected from the group consisting of a front passenger seat, a rear driver side seat, a rear middle seat and a rear passenger side seat.

4. The system as set forth in claim 1 wherein the transmitter comprises a radio-frequency identification (RFID) device which is interrogated by the toll collection infrastructure system.

5. The system as set forth in claim 1 wherein the transmitter comprises a transmitter selected from the group consisting of a BlueTooth transmitter, a Wi-Fi transmitter, and an infrared transmitter.

6. The system as set forth in claim 1 wherein the count is presumed to include at least one human occupant for a driver's seat.

7. The system as set forth in claim 1 wherein at least one of the seat occupancy detectors is provided on an inside of the vehicle in a position having an unobstructed view of the one or more passenger seats, and wherein the controller is configured to use one or more sensor inputs to avoid counting objects and animals as human occupants.

8. The system as set forth in claim 1 wherein the system is provided as a battery-powered or solar-powered device placed proximal to a front of a vehicle dashboard, thereby providing a transmission path outside the vehicle to the toll collection infrastructure system, and thereby providing the sensor unit a view towards the one or more seats within the vehicle.

9. The system as set forth in claim 1 wherein the controller is further for receiving inputs from a plurality of different technology sensor types, and for using the different inputs to confirm the likelihood of a human occupant in a seat.
